(19) United States
(12) Patent Application Publication
(10) Pub. No.: US 2007/0166093 A1
(43) Pub. Date: Jul. 19, 2007

(54) Automatic opening device for a printer gate

(75) Inventor: Alberto Campanini, Fidenza (Parma) (IT)

Correspondence Address: LACKENBACH SIEGEL, LLP, LACKENBACH SIEGEL BUILDING, 1 CHASE ROAD, SCARSDALE, NY, 10583, US

(73) Assignee: Custom Engineering Spa, Fidenza (Parma) (IT)

(21) Appl. No.: 11/581,770

(22) Filed: Oct. 16, 2006

(30) Foreign Application Priority Data
Jan. 18, 2006 (EP) 06425022.8

(51) Int. Cl. B41J 29/00; B41J 29/13

(52) U.S. Cl. 400/693

(57) ABSTRACT

An automatic opening device for a printer having an openable/closeable gate for providing access to a printer housing for housing a paper roll onto which information is to be printed and housing other printer parts, comprising a rotatable shaft for carrying a printer roll for printing onto paper carried by a paper roll in the printer housing a sensor operatively associated with the paper roll for sensing when the end of the paper carried by the paper roll is reached, a gate lifting mechanism coupled to the gate to lift the gate for opening the printer housing to provide access to the paper roll, and an arrangement responsive to the sensor when sensing the end of the paper to operate the gate lifting mechanism to open the gate for providing access to the paper roll to change the paper.

### BACKGROUND OF THE INVENTION

1. Field of the Invention

This invention is concerned with an opening device or mechanism for automatically opening the gate of a printer for providing access to a paper supply area when the paper supply is exhausted.

2. Description of the Prior Art

At present, in commercial establishments when the supply of printing paper is exhausted, there is usually a delay causing inconvenience to customers at check-out counters. Printed papers are generally used for vouchers, sales totals and itemization of articles purchased to provide a record for both the purchaser and the vender.

Additionally, at present it is necessary to open the printer in order to check the quantity of paper remaining within the printer and to obtain some idea as to when the paper supply is exhausted.

In the field of printers that use paper derived from a paper roll, different apparatuses are known to use a signal to indicate when the end of the paper is reached. These apparatuses generally signal to the user when there is a lack of paper by using outside indicia indicators and/or by means of a software control.

In the less expansive printers, the job to check the presence of paper inside the printer is given to the user who manually opens the gate of the printer housing in which the paper is situated or stored, and such individual periodically manually checks the residual paper quantity. This periodic checking causes considerable delay and lost time at the check-out area.

Present day printers are also equipped with dial lamps and are opened periodically to control both the actual situation of the paper quantity and as well as to proceed with a substitution or addition of the roll of paper.

Present day printers require careful checking periodically to ascertain when it is necessary to replace the paper supply, thereby creating unnecessary delay and inconvenience to customers at a check-out counter. At times, when the printer is opened the paper supply roll becomes dislodged, thereby providing for further waste and delay.

### SUMMARY OF THE INVENTION

To these ends, the invention consists in the provision of an automatic opening device for a printer having an openable/closeable gate for providing access to a printer housing for housing a paper roll onto which information is to be printed and other printer parts, in which there is provided a rotatable shaft for carrying a printer roll for printing onto paper carried by the paper roll housed in the printer housing, a sensor operatively associated with the paper roll for sensing when the end of the paper carried by the paper roll is reached, a gate lifting mechanism coupled to the gate and responsive to the sensor for lifting the gate to open the housing for the printer to provide access to the paper roll housed in the printer housing when an end of the paper on the paper roll is reached, and a mechanism responsive to the sensor to sense when the end of the paper on the paper roll contained within the housing is reached for enabling access to the paper roll to be provided to permit removal of the paper roll and replacement thereof and cooperating with the gate lifting mechanism for rendering thereof operable to cause the gate lifting mechanism to raise or open the openable/closeable gate in response solely to the sensor sensing when the end of the paper is reached.

The mechanism responsive to the sensor includes an unidirectional bearing carried by said rotatable shaft, the unidirectional bearing having an outer substantially cylindrical ring portion and movable in only one direction, a gear wheel having an inner opening of a diameter to fit onto and over the outer ring portion and the gear wheel having an outer set of ring teeth, a bearing mechanism including first and second components, the first component having a first part provided with a first set of outer gear teeth having a first diameter for engagement with said gear wheel and a second part with a second set of outer gear teeth having a second diameter having a diametric extent less than the first diameter of the first set of outer gear teeth, the second component including a first part having a set of outer gear teeth elements for engagement with the second set of outer gear teeth and a second part; and the second part of the second component including a cam carried by the second component for engaging the gate lifting mechanism coupled to the gate for disengaging the gate from the printer housing for opening the gate.

The gate lifting mechanism includes a lever associated with the gate and engageable with the cam for releasing the gate from the printer housing to activate the gate lifting mechanism to open the gate and provide access to the housing for changing the paper roll when the end of the paper on the paper roll is reached.

The rotatable shaft has a first portion extending beyond one of the edges of the printer roll, and the unidirectional bearing has a second portion providing an inner hollow portion of a diameter greater than the outer diameter of the first portion of the rotatable shaft which extends beyond the printer roll, the rotatable shaft having a recessed portion proximate to its outer end, and a holding clip is receivable in the second portion having the recessed hollow portion for receiving the clip to hold the unidirectional bearing onto the outer end of the shaft.

The gear wheel is provided with an open hollow portion to fit over the outer diameter of the unidirectional bearing.

A lever is provided coupled with the gate lifting mechanism for disengaging a spring connection holding the gate in a closed position with the printer housing, the spring connection causing the gate to move from the closed condition to an open condition.

The mechanism responsive to the sensor includes a solenoid associated with the sensor and responsive to the sensor for opening the openable/closeable gate when the sensor senses the end of the paper on the paper roll, and a movable member forming part of the solenoid is provided for contacting the gate lifting mechanism for causing the gate lifting mechanism to disengage the openable/closeable gate from the printer housing to open the gate and provide access to the printer housing.

Electrical controls are provided coupling the sensor with the solenoid for activating the solenoid when the sensor is rendered operative for detecting the end of the paper.

The movable member is a slideable core which moves into engagement with the gate lifting mechanism for activating the gate lifting mechanism to disengage the gate from its closed condition with the printer housing when the solenoid is rendered operative responsive to the sensor sensing the end of the paper on the paper roll.

A lever associated with said gate lifting mechanism and responsive to activation by the movable member to unlock the gate from the housing to enable the gate lifting mechanism to lift the gate from the printer housing.

The automatic opening device for a printer has an openable/closeable gate to provide access to the printer housing for housing the paper roll onto which information is to be printed and for housing other printer parts, and is provided with a rotatable shaft for carrying a printer roll for printing onto paper carried by the paper roll in the printer housing, a sensor including an unidirectional bearing arrangement responsive to the sensor for sensing when the end of the paper carried by the paper roll is reached and for providing access to the printer housing, a gate lifting spring operated mechanism is provided to lift the gate to open the housing for the printer to provide access to the paper roll housed in the printer housing, and a mechanism means responsive to the sensor when sensing the end of the paper on the paper roll contained within the housing for providing access to the paper roll for permitting removal thereof and cooperating with the gate lifting spring operated mechanism for rendering the gate lifting mechanism operable to raise the gate.

The unidirectional bearing arrangement includes the rotatable shaft having an outer portion to receive the unidirectional bearing, and the bearing having an outer ring portion, a gear wheel having an outer set of teeth and having an inner opening of a diameter to fit onto the outer ring portion, a bearing mechanism including a first component including a first set of outer gear teeth for engagement with the teeth of the gear wheel and a first part with a second set of outer gear teeth at a diameter less than the diameter of the first set of outer gear teeth, and a second component including a second part having a set of outer gear teeth elements for engagement with the second set of outer gear teeth, and a cam carried by the second component for engaging the lifting mechanism gate for opening the gate.

The automatic opening device for a printer according to the invention includes an openable/closeable gate for providing access to a printer housing for housing a paper roll onto which information is to be printed and housing other printer parts, and is provided with a rotatable shaft for carrying a printer roll for printing onto paper carried by a paper roll in the printer housing, a sensor operatively associated with the paper roll for sensing when the end of the paper carried by the paper roll is reached, a gate lifting mechanism coupled to the gate to lift the gate for opening the housing for the printer to provide access to the paper roll housed in the printer housing, and a solenoid arrangement responsive to the sensor when sensing the end of the paper on the paper roll contained within the housing for providing access to the paper roll for permitting removal thereof and cooperating with the gate lifting mechanism for rendering the gate lifting mechanism operable to raise the electrical connectors is also provided for coupling the sensor with the solenoid for the solenoid for activation thereof when the sensor is rendered operative for detecting the end of the paper.

An advantage of the present invention is to provide substantially immediate information to a printer operator as to when the paper supply is exhausted, so that a paper change can be made at the convenience to the printer operator, as well as with a minimum delay to others.

A feature of the invention is that notification is provided to the user or printer operator that the paper supply is exhausted or substantially exhausted without the necessity of or use of dial or other indicator lamps or any other conventional indicia separate and apart from the printer.

The present invention provides for an accurate opening of the printer only when access is necessary to replace the paper supply.

The present invention therefore provides for a dual advantage, firstly is to avoid useless openings of the printer, and secondly to advise or inform the printer operator without use of dial lamps or other separate indicia, that the paper supply is exhausted or nearing exhaustion. An aim of the present invention is to provide for rapid substitution of the paper roll.

According to the teaching of this invention, in particular in commercial stores, where long lines may be formed at the check-out counters due to delays in changing the paper roll and the necessity to check the paper roll periodically, there is an advantage to all to reduce delay.

The device of the present invention, instead, provides for an automatic opening of the printer only when such opening is necessary to maintain the proper functioning of the printer. To provide for this automatic opening, the present device essentially uses common components for all printers that employ paper rolls for printing of information with small changes and integrations to create an easy and inexpensive device.

The automatic opening device for the printer assures that the gate lifting mechanism is only operable to raise the openable/closeable gate in response solely to the sensor sensing when the end of the paper is reached.

The rotatable shaft has a portion extending beyond one of the edges of the printer roll, and the unidirectional bearing is provided with an inner hollow portion of a diameter greater than the outer diameter of the portion of the rotatable shaft which extends beyond the printer roll, and the rotatable shaft is provided with a recessed portion proximate to its outer end, which cooperates with a holding clip receivable in the recessed hollow portion for receiving the clip to hold the unidirectional bear onto the outer end of the shaft.

The gear wheel is provided with an open hollow portion to fit over the outer diameter of the unidirectional bear.

### LIST OF REFERENCE NUMERALS

The following is a list of the elements and reference numerals designating the aforesaid elements:
1. gate
2. lifting or opening
3. closing/opening mechanism
4. electric motor—stepping or stepper motor
5. gearing
6. printer roll
7. end paper sensor
8. unidirectional bearing
9. shaft
10. hollow
11. ring holder
12. gear wheel having teeth fixed to bearing 8
13. bearing
14. cam
15. solenoid
16. connect cables
17. electric device
18. central metallic part.

### BRIEF DESCRIPTION OF THE DRAWINGS

FIG. 1 is a perspective view of an opened printer containing a printer roll and provided with a unidirectional bearing according to one embodiment of the invention;

FIG. 2 is another perspective view of the open roll printer of FIG. 1 partially disassembled with removed parts shown juxtaposed to the printer;

FIG. 3 is a partially perspective view of the unidirectional bearing 8, ring holder 11 and gear 12 which are placed onto hollow shaft 9 forming part of printer roll 6;

FIG. 4 is another perspective view of the printer in its closed condition with a side opened for viewing internal parts without fixed gear wheel 12, bearing 13 and cam 14;

FIG. 5 is a lateral or side view of the printer with a side cover removed showing gate 1, return spring 2, closing and opening mechanism 3, stepping motor 4, paper end sensor 7, fixed gear wheel 12 and bearing 13; and

FIG. 6 is an exploded perspective view of a second embodiment of the invention of an opened roll printer showing gate 1 in its open position, return spring 2, gearing 5, printer roller 6 and solenoid 15, connect-cables 16, electric device 17 (shown in dashed outline), and central metallic part 18.

### DESCRIPTION OF THE PREFERRED EMBODIMENTS

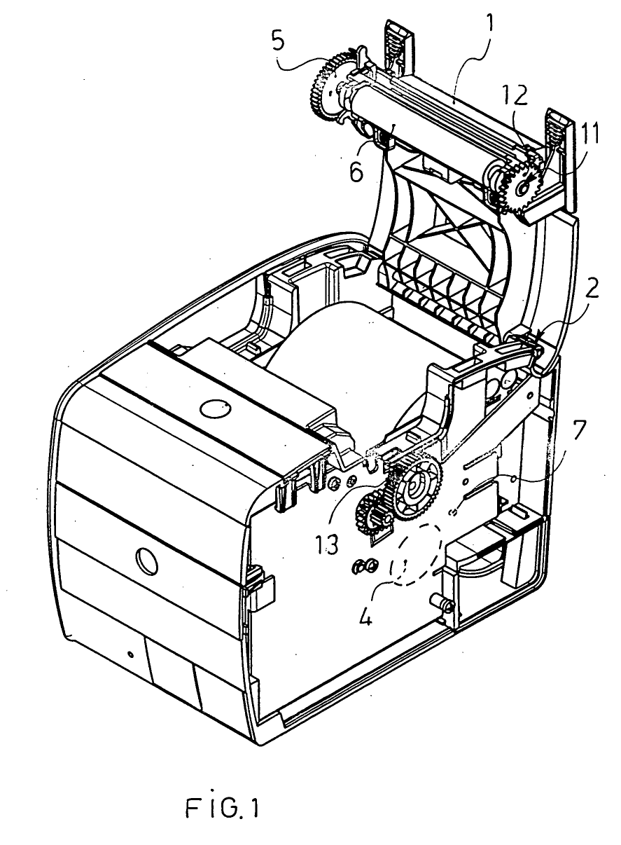

Referring now more particularly to the accompanying drawings and more specifically to FIGS. 1 to 5 which show one embodiment of the invention, and in which the same reference numerals in all of the figures designate the same components.

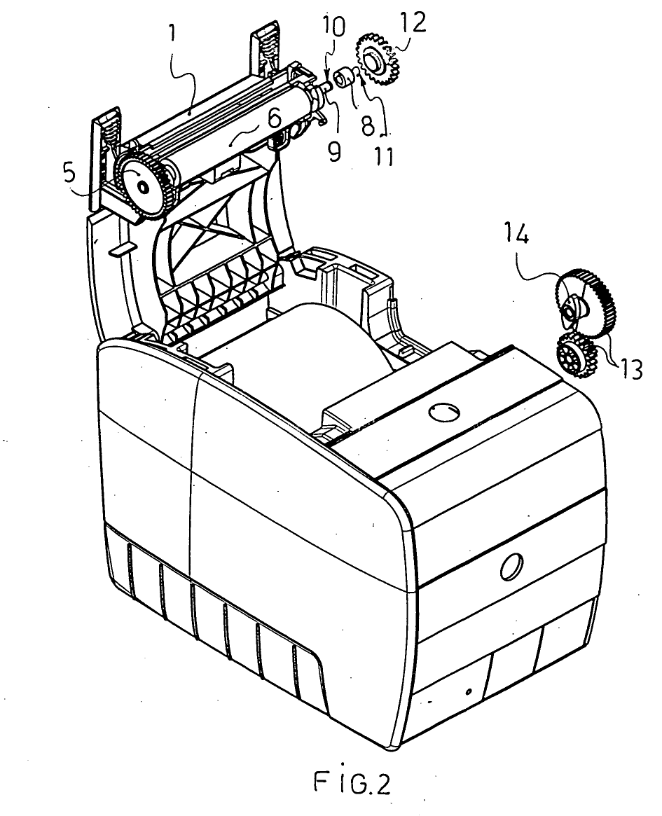

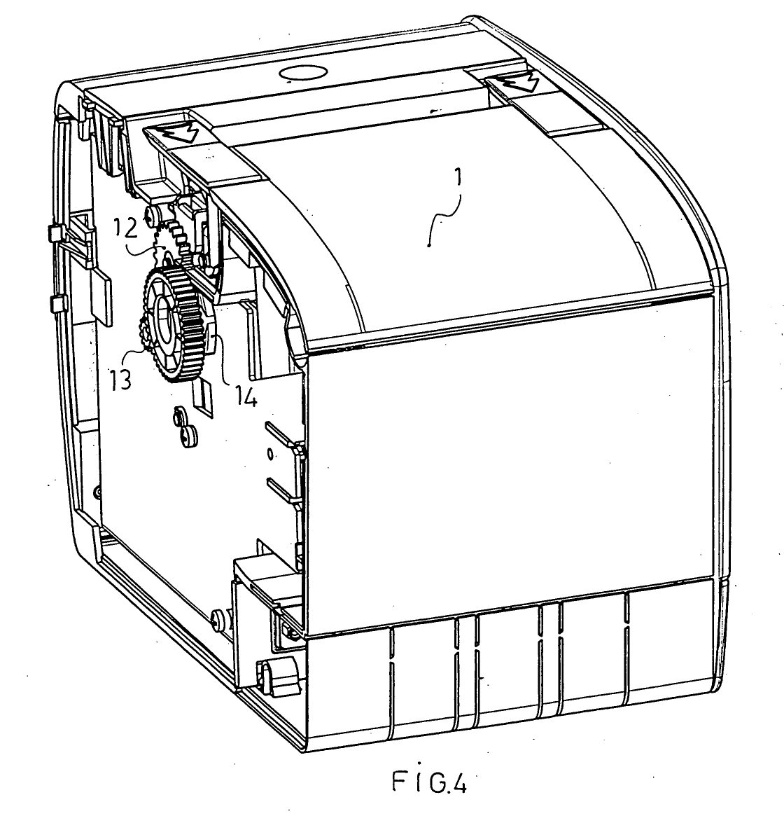

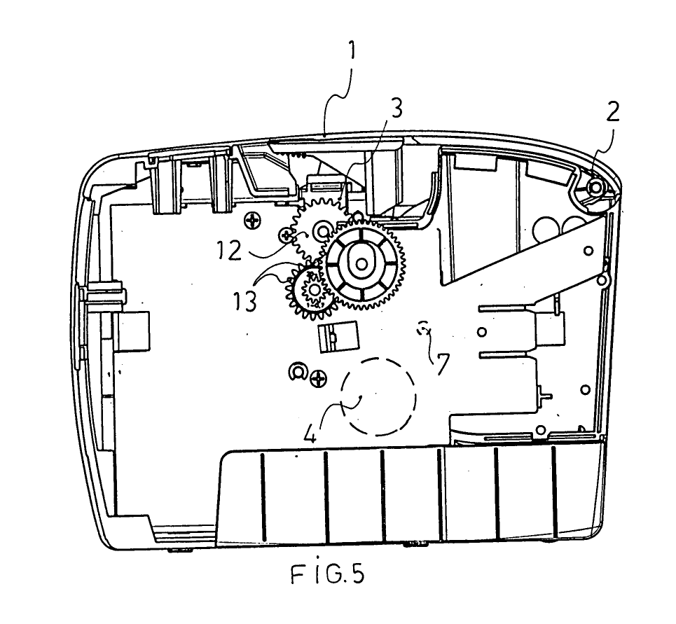

As best seen in FIG. 1 a printer is shown provided with a movable gate 1 shown in its open position to illustrate the inner parts, the gate being movable from its open position as shown in FIG. 1 to its closed position as shown in FIGS. 4 and 5. Spring 2 (FIG. 2) is provided to lift gate 1 from its closed position and is provided with sufficient stretchability or elasticity to permit gate 1 to be moved or lifted from its closed position to its open position upon opening of gate 1. Spring 2 is instrumental in opening gate 1 and moving it from its closed position relative to the paper housing to its open position to provide access to the paper roll.

Spring 2 is connected between gate 1 and a part forming the inner housing of the printer.

Opening/closing mechanism 3 (FIG. 5) maintains gate 1 in a closed condition during operation of the printer and opens or causes gate 1 to be opened upon sensing the end of the paper. A conventional paper roll (FIG. 1) is connected with a stepping motor 4 by means of bearing 5 or toothed gear 5.

In the open phase of gate 1, spring 2 cooperates with opening/closing mechanism to lift gate 1 from the body of the printer housing to open the printer housing for access to the paper roll.

The printer is provided with the conventional paper roll operatively coupled with stepper motor 4 for advancing paper from a paper roll to printer roll 6 when gate 1 is in its closed position. For this purpose the stepping motor 4 is used and the motor 4 advances the paper from the paper roll to a printing head.

End paper sensor 7, FIGS. 1 and 5, is responsive to note or be activated when the end of the paper is removed from the paper roll so that a new paper roll should be installed.

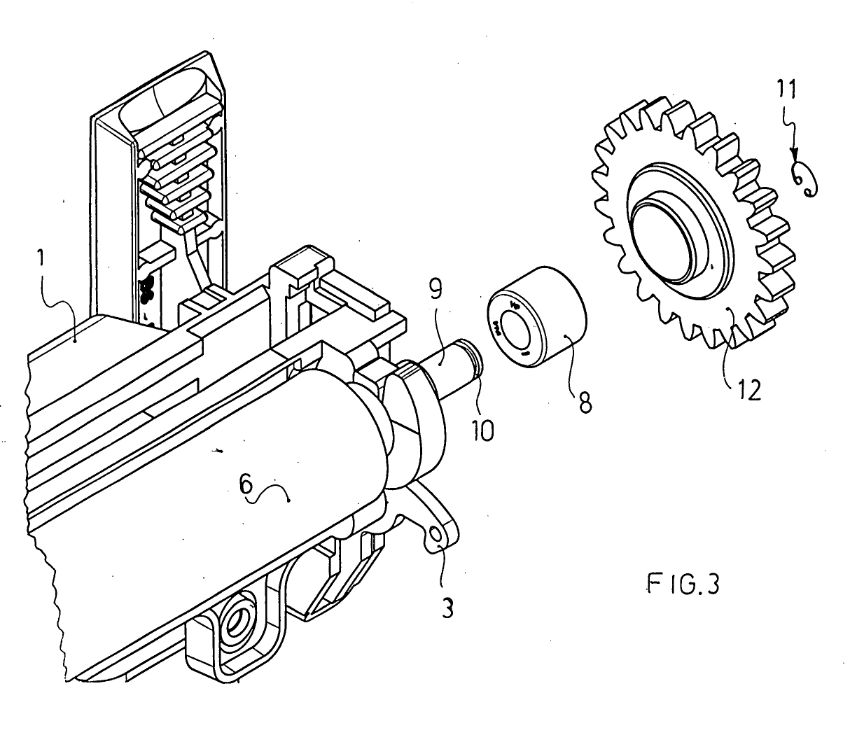

In accordance with the first embodiment, a unidirectional bearing 8, FIGS. 2 and 3, is provided which is placed or positioned onto an extended portion of shaft 9, which also carries printer roll 6 and the extended portion is beyond the printer roll. Shaft 9 is provided with a recessed portion at an end part thereof for receiving on the outer circumferential surface thereof ring Seeger 11 for retaining unidirectional bearing 8 on the end of shaft 9.

Gear wheel 12 having teeth and is coaxially fitted onto unidirectional bearing 8. The bearing 13 includes two parts, a bearing part forming a gear wheel having outer gear teeth which mesh with a second bearing part. The bearing 13 comprises two portions, a first portion 13 having teeth which mesh with the teeth of gear wheel 12 when gate 1 is closed. The bearing 13 also includes a second portion having outer teeth which mesh with cam carrying element on cam 14. The cam carrying element is joined with cam 14 which engages a lever for opening gate 1. The lever is associated with the gate lifting mechanisms and responsive to the activation by the movable member to unlock the gate from the housing return spring 2. Gear wheel 12 has outer circumferential teeth which mesh with the gear teeth on bearing 13 and rotate together such that the rotation of gear wheel 12 transmits or imparts its own angular motion to bearing 13. Bearing 13 also includes a gear member or part which supports cam 14 and is coaxial with the bearing 13. Cam 14 and gear wheel 12 are coaxial with each other.

Cam 14 is provided with an outer profile such that it comes into contact with the lever associated with the opening/closing mechanism 3 for movement of the lever to unfasten gate 1 from the body of the printer enclosure.

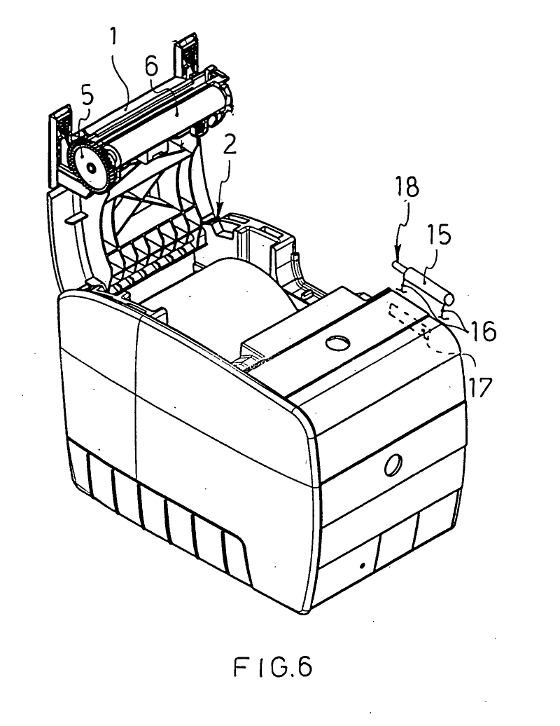

Referring now more particularly to FIG. 6 in which like parts in FIGS. 1 to 5 have the same reference numerals. In this embodiment, solenoid 15 and its associated parts replace unidirectional bearing 8 and its associated parts.

Paper in this embodiment is advanced also to printer roll 6 which is connected with electric stepper or stepping motor 4.

Paper sensor 7 sends a signal or impulse to the stepper motor 4 through conventional electronic transmission means. Motion is transmitted to printer roller 6 by means of gearing 5 which is coupled with stepper motor 4 when gate 1 is closed and shaft 9 as in FIG. 2 which carries printing roll 6.

Unidirectional bearing 8 transmits motion to gear wheel 12. Rotation is transmitted to bearing mechanism 13 and to coaxial cam 14 fixed onto bearing 13. Cam 14 when moved lifts gate 1 from its locked condition and permits gate 1 to be opened in response to opening/closing mechanism 3. Spring 2 lifts of gate 1, and the inside portion of the printer is accessed to change the paper roll.

In the second embodiment, when sensor 7 senses the end of the paper roll solenoid 15 is coupled by means of electrical wires or cables 16 to electrically operated devices. Operation of solenoid 15 provides for transfer of central metallic part or slideable core 18 and permits opening of gate 1 as it acts onto a lever of the opening/closing mechanism 3, unfastening gate 1 with spring 2 that provides for lifting of gate 1.

While there has been shown what is considered to be the preferred embodiments, it will be obvious to those skilled in the art that various changes and modifications may be made without departing from the scope of the invention.

1. An automatic opening device for a printer having an openable/closeable gate for providing access to a printer housing for housing a paper roll onto which information is to be printed and other printer parts, comprising:
a rotatable shaft for carrying a printer roll for printing onto paper carried by said paper roll housed in the printer housing;
a sensor operatively associated with said paper roll for sensing when the end of the paper carried by said paper roll is reached;
a gate lifting mechanism coupled to said gate and responsive to said sensor for lifting said gate to open the housing for the printer for providing access to the paper roll housed in said printer housing when an end of the paper on said paper roll is reached; and
means responsive to said sensor for sensing when the end of the paper on the paper roll contained within said housing is reached for enabling access to said paper roll to be provided for permitting removal of said paper roll and replacement thereof and cooperating with said gate lifting mechanism for rendering said gate lifting mechanism operable to cause said gate lifting mechanism to raise said openable/closeable gate in response solely to said sensor sensing when the end of said paper is reached.

2. The automatic opening device claimed in claim 1, wherein said sensor responsive means includes:
an unidirectional bearing carried by rotatable shaft, said unidirectional bearing having an outer substantially cylindrical ring portion;
said outer ring portion and said gear wheel having an outer set of ring teeth;
a bearing mechanism including first and second components;
said first component having a first part provided with a first set of outer gear teeth having a first diameter for engagement with said gear wheel and a second part with a second set of outer gear teeth having a second diameter having a diametric extent less than the first diameter of said first set of outer gear teeth, said second component including a first part having a set of outer gear teeth elements for engagement with said second set of outer gear teeth and a second part; and
said second part of said second component including a cam carried by said second component for engaging said gate lifting mechanism gate for disengaging said gate from said printer housing for opening said gate.

3. The automatic gate opening device as claimed in claim 1, wherein
said gate lifting mechanism includes a lever associated with said gate and engageable with said cam for releasing said gate from said printer housing to activate said gate lifting mechanism to open said gate and provide access to said housing for changing the paper roll when the end of the paper on said paper roll is reached.

4. The automatic open device as claimed in claim 2, wherein
said rotatable shaft has a first portion extending beyond one of the edges of said printer roll, and
said unidirectional bearing has a second portion providing an inner hollow portion of a diameter greater than the outer diameter of the first portion of said rotatable shaft which extends beyond said printer roll, said rotatable shaft having a recessed portion proximate to its outer end, and
a holding clip receivable in said second portion having said recessed hollow portion for receiving said clip to hold said unidirectional bearing onto the outer end of said shaft.

5. The automatic device as claimed in claim 4, wherein said gear wheel is provided with an open hollow portion to fit over the outer diameter of said unidirectional bearing.

6. The automatic opening device as claimed in claim 1, including a spring and a lever coupled with said gate lifting mechanism for enabling the spring to move said gate to an open condition from a closed position with said printer housing.

7. The automatic opening device as claimed in claim 1, wherein said sensor responsive means comprises:
a solenoid associated with said sensor and responsive to said sensor for opening said openable/closeable gate when said sensor senses the end of the paper on said paper roll; and,
a movable member forming part of said solenoid for contacting said gate lifting mechanism for causing said gate lifting mechanism to disengage said openable/closeable gate from said printer housing to open said gate and provide access to said printer housing.

8. The automatic opening device as claimed in claim 7, including:
electrical means coupling said sensor with said solenoid for activating said solenoid when said sensor is rendered operative for detecting the end of the paper.

9. The automatic opening device as claimed in claim 7,
wherein said movable member is a slideable core which moves into engagement with said gate lifting mechanism for activating said gate lifting mechanism to disengage said gate from its closed condition with said printer housing when said solenoid is rendered operative responsive to said sensor sensing the end of the paper on the paper roll.

10. The automatic opening device as claimed in claim 7, including a lever associated with said gate lifting mechanism and responsive to activation by said movable member to unlock said gate from said housing to enable said gate lifting mechanism to lift said gate from said printer housing.

11. An automatic opening device for a printer having an openable/closeable gate for providing access to a printer housing for housing a paper roll onto which information is to be printed and for housing other printer parts, comprising:
a rotatable shaft for carrying a printer roll for printing onto paper carried by said paper roll in the printer housing;
a sensor including an unidirectional bearing arrangement responsive to said sensor for sensing when the end of the paper carried by said paper roll is reached and for providing access to said printer housing;
a gate lifting spring operated mechanism to lift said gate to open the housing for the printer for providing access to the paper roll housed in said printer housing;
means responsive to said sensor when sensing the end of the paper on the paper roll contained within said housing for providing access to said paper roll for permitting removal thereof and cooperating with said gate lifting spring operated mechanism for rendering said gate lifting mechanism operable to raise said gate.

12. The automatic opening device as claimed in claim 11, including an unidirectional bearing arrangement comprising:
said rotatable shaft having an outer portion to receive said unidirectional bearing, and said bearing having an outer ring portion;
a gear wheel having an outer set teeth and having an inner opening of a diameter to fit onto said outer ring portion;
a bearing mechanism including first and second components;
said first component including a first set of outer gear teeth for engagement with the teeth said gear wheel and a first part with a second set of outer gear teeth at a diameter less than the diameter of said first set of outer gear teeth, and said second component including a second part having a set of outer gear teeth elements for engagement with said second set of outer gear teeth; and
a cam carried by said second component for engaging said lifting mechanism gate for opening said gate.

13. An automatic opening device for a printer having an openable/closeable gate for providing access to a printer housing for housing a paper roll onto which information is to be printed and housing other printer parts, comprising:
a rotatable shaft for carrying a printer roll for printing onto paper carried by a paper roll in the printer housing;
a sensor operatively associated with said paper roll for sensing when the end of the paper carried by said paper roll is reached;
a gate lifting mechanism coupled to said gate to lift said gate for opening the housing for the printer for providing access to the paper roll housed in said printer housing; and
means including a solenoid arrangement responsive to said sensor when sensing the end of the paper on the paper roll contained within said housing for providing access to said paper roll for permitting removal thereof and cooperating with said gate lifting mechanism for rendering said gate lifting mechanism operable to raise said gate.

14. The automatic opening device as claimed in claim 13, including:
electrical means coupling said sensor with said solenoid for activating said solenoid when said sensor is rendered operative for detecting the end of the paper.
